(19) United States
(12) Patent Application Publication
(10) Pub. No.: US 2019/0325677 A1
(43) Pub. Date: Oct. 24, 2019

(54) HOME SECURITY SYSTEM WITH AUTOMATIC AUTHORIZATION FUNCTIONALITY

(71) Applicant: Carrier Corporation, Palm Beach Gardens, FL (US)

(72) Inventors: Ramesh Lingala, Palm Beach Gardens, FL (US); Santhosh Amuduri, Palm Beach Gardens, FL (US)

(21) Appl. No.: 15/984,672

(22) Filed: May 21, 2018

(30) Foreign Application Priority Data
Apr. 24, 2018 (IN) 201811015456

(51) Int. Cl. G07C 9/00

(52) U.S. Cl. CPC G07C 9/00309; G07C 2009/00769

(57) ABSTRACT

A residential security system includes a central security system and a plurality of offline security system components. Each of the offline security system components is directly connected to the central security system. At least one door lock includes a mobile credentialing system. The central security system includes software configured to automatically authorize an entry in response to receiving an authorized mobile credential from the at least one door lock system.

### CROSS-REFERENCE TO RELATED APPLICATION

This application claims priority to Indian Provisional Application No. 201811015456 filed on Apr. 24, 2018.

### TECHNICAL FIELD

The present disclosure relates generally to building security systems, and more specifically to an improved home security system including an automatic authorization functionality.

### BACKGROUND

Home security systems, as well as security systems in other types of residential buildings, activate upon access through an entry point. In a typical system, once a resident has entered at the entry point, and the system is activated, the user will have a limited period to deactivate the security system by indicating to the security system that the user is authorized to access the system. Users can indicate this authorization by entering an access code, biometric key, or any manual authorization system at an access panel disposed near the entry point.

The requirement to enter credentials ensures that the person, or persons, entering the home is authorized to enter. If no authorization is entered to the panel within a predetermined time, the access panel triggers a security alarm. Using such a system, however, requires a decision of how much time to allow a user to enter the code. Insufficient time can result in a false alarm when the user was unable to enter the code in time. Too much time has the opposite problem, where an unauthorized person may be able to access the house, grab one or more items and leave before the alarm is triggered.

### SUMMARY OF THE INVENTION

An exemplary method for automatically authorizing an entrant in a residential security system includes unlocking at least one entryway in a residential building in response to a door lock receiving an authorized mobile credential, transmitting a first notice from the door lock to a central security system, wherein the notice includes at least one of an identity corresponding to the mobile credential and data indicative of an authorized entrance, and transmitting a second notice from the central security system to at least one offline security system component in response to the first notice, wherein the second notice includes an indication that an authorized entrant has passed through the at least one entryway.

In another example of the above described method for automatically authorizing an entrant in a residential security system unlocking at least one entryway in response to the door lock receiving the authorized mobile credential comprises unlocking a subset of entryways in the residential building and allowing a remainder of entryways in the residential building to remain locked.

Another example of any of the above described methods for automatically authorizing an entrant in a residential security system further includes prompting a mobile device owned by a user corresponding to the authorized mobile credential to verify that the user has accessed the door lock.

In another example of any of the above described methods for automatically authorizing an entrant in a residential security system the verification is at least one of a button push, a code entry, and a biometric key.

In another example of any of the above described methods for automatically authorizing an entrant in a residential security system transmitting the first notice comprises transmitting the first notice over a direct connection.

In another example of any of the above described methods for automatically authorizing an entrant in a residential security system transmitting the first notice comprises transmitting the first notice over a network connection.

In another example of any of the above described methods for automatically authorizing an entrant in a residential security system unlocking the at least one entryway in the residential building in response to the door lock receiving the authorized mobile credential occurs in response to a communication from a mobile credentialing server.

In another example of any of the above described methods for automatically authorizing an entrant in a residential security system the mobile credentialing server is a component of a central security system.

In another example of any of the above described methods for automatically authorizing an entrant in a residential security system the mobile credentialing system is connected to the central security system via a network.

Another example of any of the above described methods for automatically authorizing an entrant in a residential security system further includes transmitting a received mobile credential to the mobile credentialing server in response to receiving the mobile credential at the door lock and prior to unlocking the at least one entryway.

In another example of any of the above described methods for automatically authorizing an entrant in a residential security system the central security system automatically performs one of arming the security system, disarming the security system, transferring the security system to a home mode and transferring the security system to an away mode in response to receiving the first notice.

In another example of any of the above described methods for automatically authorizing an entrant in a residential security system the central security system automatically prompts a mobile device to display an arm system option in response to receiving the authorized mobile credential.

In one exemplary embodiment a residential security system includes a central security system, a plurality of offline security system components, each of the offline security system components being directly connected to the central security system, at least one door lock including a mobile credentialing system, and wherein the central security system includes software configured to automatically authorize an entry in response to receiving an authorized mobile credential from the at least one door lock system.

In another example of the above described residential security system the plurality of offline security system components include at least one of a window sensor and a garage sensor.

In another example of any of the above described residential security systems at least one of the security system components in the plurality of security system components is wireless connected to the central security system.

In another example of any of the above described residential security systems a mobile credentialing server is included within the central security system.

In another example of any of the above described residential security systems a mobile credentialing server is connected to the central security system and the at least one door lock via a network.

In another example of any of the above described residential security systems the door lock is an offline component.

In another example of any of the above described residential security systems the door lock includes a local wireless communication protocol and is configured to communicate with at least one mobile device using the local wireless communication protocol.

In another example of any of the above described residential security systems the door lock is directly connected to at least one of the central security system and a mobile credentialing server.

These and other features of the present invention can be best understood from the following specification and drawings, the following of which is a brief description.

### BRIEF DESCRIPTION OF THE DRAWINGS

FIG. 1 illustrates an exemplary residential building including a security alarm system.

FIG. 2 schematically illustrates the security alarm system of claim 1 with the inclusion of multiple optional features.

FIG. 3 schematically illustrates a method for operating the security alarm systems of FIGS. 1 and 2.

### DETAILED DESCRIPTION OF AN EMBODIMENT

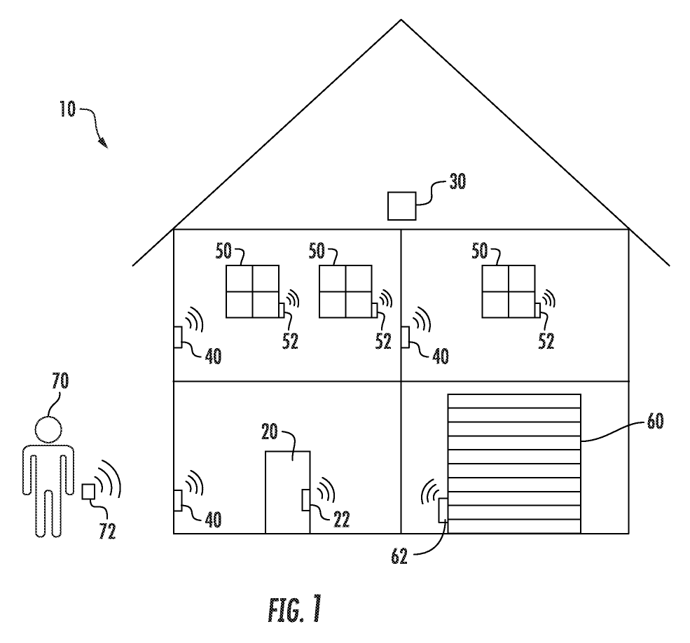

FIG. 1 schematically illustrates an exemplary residential building 10 including an integrated security alarm system. The illustrated residential building 10 is a house, however it is appreciated that the system and method described herein can be applied to any other residential building including apartment complexes, dormitories, barracks, and the like.

Included within the residential building 10 is at least one entryway 20, such as a door. The entryway 20 includes a door lock system 22. The door lock system 22 is configured to connect to a central security system 30 via a direct connection within the house and is capable of operating in conjunction with a mobile credentialing system. While illustrated herein as a wireless connection, it should be appreciated that the direct connection can be wired, or a combination of wireless and wired in alternative examples. As used herein, direct connections are communication connects that flow directly from one device to another device without being incorporated into a broader communications network.

Disposed in multiple rooms of the residential building 10 are access panels 40. Each of the access panels 40 provides an interface that allows a user in the room to interact with the central security system 30 and disable, or enable, the central security system 30. Positioned at each of the windows 50 are one or more sensors 52. The sensors 52 are any conventional window sensor for detecting entry through the window, and are connected to the central security system 30 via a direct connection. In addition to the window sensors 52, each of the rooms can include any number of other security system components also connected to the central security system 30 via a direct connection. One or more of the security system components is connected only to the central security system 30, and is not part of a broader network.

In some examples, such as the illustrated residential building 10 of FIG. 1, a garage door 60 can be included. In such examples, the garage door 60 can be paired with a garage sensor 62, and the garage sensor 62 is connected to the central security system 30 via a direct connection in the same manner as the access panels 40 and the window sensors 52.

To gain access to the residential building 10 through the entryway 20, a user 70 presents a mobile device 72 containing credentialing software having matching credentials for the door lock system 22. The credentialing software is configured to provide access credentials stored on the mobile device 72 to the door lock system 22. The mobile device 72 communicates with the door lock system 22 to unlock the entryway 20, and allow the user 70 to enter the residential building 10. In some examples, the mobile device 72 can be connected to, or able to connect to, the central security system 30 via a network, such as the internet, and connects to the door lock system 22 through the central security system 30. In alternative examples, the mobile device 70 connects directly to the door lock system 22 through a local wifi communication protocol such as Bluetooth or any similar communication protocol.

Once the mobile device 72 has connected with the door lock system 22 and entry to the residential building 10 has been granted, the door lock system 22 verifies the user 70 and automatically informs the central security system 30 that the entry is authorized, and no alarm should be triggered. In alternative examples, the door lock system 22 can prompt the mobile device 72 to display a verification screen, and allow the user 70 to verify that they are authorized to enter. The verification can be a simple button push, and entry of a code, provision of a biometric key, or any other verification means. Once the central security system 30 has verified the authenticity of the user, the central security system 30 notifies each connected component via the corresponding direct connection.

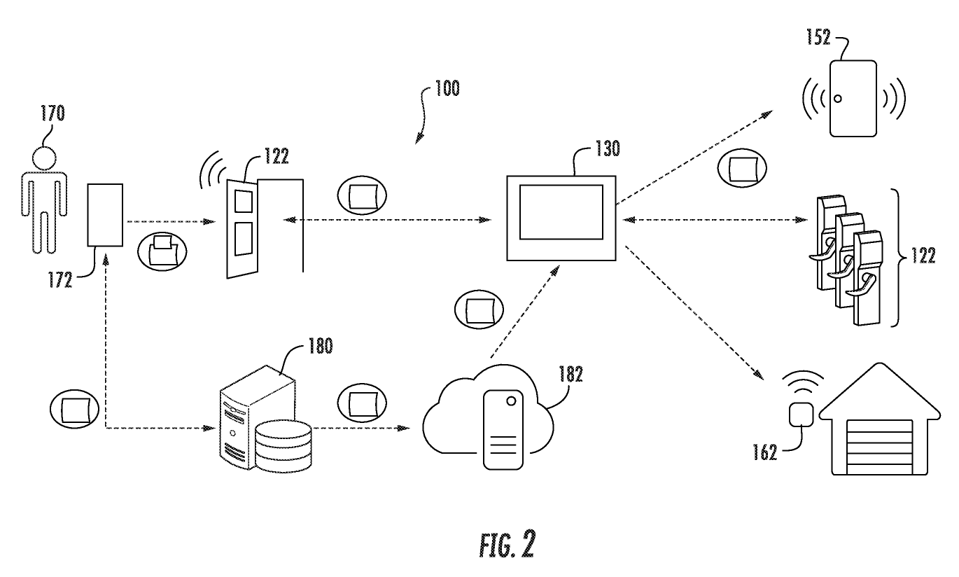

With continued reference to FIG. 1, and with like numerals indicating like elements, FIG. 2 schematically illustrates a security system 100 without the context of the residential building 10. The security system 100 includes multiple door locks 122, each of which is connected to a central security panel 130 via a corresponding wireless connection, such as a Bluetooth low energy (BTLE) protocol. In alternative examples, the connection can be wired, or a combination of wireless and wired. Also connected to the central security panel 130 are one or more window sensors 52, one or more garage sensors 62, and/or any number of additional security system components.

When an authorized user 170 interacts with one of the door locks 122, via a mobile device 172, the door locks 122 open and authorize. Once the door locks 122 have opened and authorized, the door locks 122 transmit a specialized network packet, such as a Bluetooth low energy packet, to the central security panel 130. The central security panel 130 then informs each of the other devices 152, 122, 162 of the authorized entry via the corresponding connections.

In the illustrated example of FIG. 2, a mobile credentialing server 180 is integrated into the system, and communicates with the user's mobile device 172, as well as with the central security panel 130 to facilitate keyless access using the mobile device 172. In the illustrated example, the mobile credentialing server 180 is connected to the central security system 130 via a cloud server 182. In alternative examples, the mobile credentialing server 180 can be directly connected to the central security system 130, or included within the central security system 130 as a software module. The mobile credentialing server 180 can use any established mobile credentialing protocol or system to provide the mobile device 172 with mobile access to the door lock 122. In yet further alternative examples, the credentials can take the form of mobile identity, room door id numbers, location id, or any similar credentialing system.

While illustrated in the examples as including a single entryway, one of skill in the art will appreciate that the system 100 can include any number of entryways each having their own door locks 122. Further, in some examples including multiple entryways, the access of a single user can be authorized at a subset of the entryways, and unauthorized at a remainder of the entryways. In such an example, the authorized credentials for any given door lock system can be either stored locally at the door lock 122, or remotely at the mobile credentialing server 180.

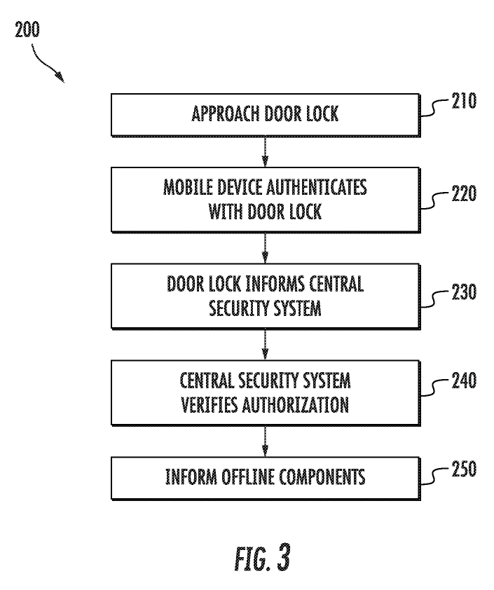

With continued reference to FIGS. 1 and 2, FIG. 3 illustrates a method 200 for automatically verifying a user entering an entryway. Initially, the user approaches an entryway secured via a door lock system including mobile door lock credentials in an “Approach Door Lock” step 210. As the user approaches, a mobile device held by the user authenticates with the door lock by providing access credentials to the door lock in a “Mobile Device Authenticates with Door Lock” step 220. The door lock credentialing can be according to any mobile door credentialing system and grants the user access to the entryway.

Once the door lock and the door verify the credentials lock grants access, the door lock transmits a specialized information packet to a central security system in a “Door Lock Informs Central Security System” step 230. In some examples the specialized information packet can include the identity of a user that corresponds to the mobile credential utilized to unlock the door locks. In another example, the specialized information packet can act as a passthrough, passing the mobile credentials on to the central security system. The central security system then automatically verifies that the user is authorized to pass through the entryway in a “Central Security System Verifies Authorization” step 240. In some examples, this authorization can be via a communication with a credentialing server. In alternative examples, this authorization can occur via comparison of the access credentials against a list of known access credentials for authorized users.

Once the user's authorization has been verified, the central security system informs offline components (e.g. system components directly connected to the central security system and not part of a broader network) that the user is authorized in an “Inform Offline Components” step 250. Informing the offline components that an authorized user has passed through the entryway causes each of the offline components to perform a predetermined response. By way of example, the predetermined response can arm the security system, disarm the security system, transfer the security system from a home mode to an away mode and vice versa, or perform any other appropriate response.

By utilizing the above system and method, multiple functions of the home security system that would normally be required to be entered at the central security system, or at an access panel connected to the central security system via a network, can be performed automatically. As noted above one such system is the verification that the individual accessing the door is not an intruder. Another exemplary system is the toggling of privacy settings, the toggling of a lock between a locked and unlocked state, or any similar settings.

Further, in some examples, the particular credentials used can be tied to a specific individual. In such examples, the central security system can notify only the offline systems that correspond to areas of the residential building in which the user is authorized to be of the entry.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A method for automatically authorizing an entrant in a residential security system comprising:
unlocking at least one entryway in a residential building in response to a door lock receiving an authorized mobile credential;
transmitting a first notice from the door lock to a central security system, wherein the notice includes at least one of an identity corresponding to the mobile credential and data indicative of an authorized entrance; and
transmitting a second notice from the central security system to at least one offline security system component in response to the first notice, wherein the second notice includes an indication that an authorized entrant has passed through the at least one entryway.

2. The method of claim 1, wherein unlocking at least one entryway in response to the door lock receiving the authorized mobile credential comprises unlocking a subset of entryways in the residential building and allowing a remainder of entryways in the residential building to remain locked.

3. The method of claim 1, further comprising prompting a mobile device owned by a user corresponding to the authorized mobile credential to verify that the user has accessed the door lock.

4. The method of claim 3, wherein the verification is at least one of a button push, a code entry, and a biometric key.

5. The method of claim 1, wherein transmitting the first notice comprises transmitting the first notice over a direct connection.

6. The method of claim 1, wherein transmitting the first notice comprises transmitting the first notice over a network connection.

7. The method of claim 1, wherein unlocking the at least one entryway in the residential building in response to the door lock receiving the authorized mobile credential occurs in response to a communication from a mobile credentialing server.

8. The method of claim 7, wherein the mobile credentialing server is a component of a central security system.

9. The method of claim 7, wherein the mobile credentialing system is connected to the central security system via a network.

10. The method of claim 7, further comprising transmitting a received mobile credential to the mobile credentialing server in response to receiving the mobile credential at the door lock and prior to unlocking the at least one entryway.

11. The method of claim 1, wherein the central security system automatically performs one of arming the security system, disarming the security system, transferring the security system to a home mode and transferring the security system to an away mode in response to receiving the first notice.

12. The method of claim 1, wherein the central security system automatically prompts a mobile device to display an arm system option in response to receiving the authorized mobile credential.

13. A residential security system comprising:
a central security system;
a plurality of offline security system components, each of the offline security system components being directly connected to the central security system;
at least one door lock including a mobile credentialing system; and
wherein the central security system includes software configured to automatically authorize an entry in response to receiving an authorized mobile credential from the at least one door lock system.

14. The residential security system of claim 13, wherein the plurality of offline security system components include at least one of a window sensor and a garage sensor.

15. The residential security system of claim 13, wherein at least one of said security system components in said plurality of security system components is wireless connected to the central security system.

16. The residential security system of claim 13, wherein a mobile credentialing server is included within the central security system.

17. The residential security system of claim 13, wherein a mobile credentialing server is connected to the central security system and the at least one door lock via a network.

18. The residential security system of claim 13, wherein the door lock is an offline component.

19. The residential security system of claim 18, wherein the door lock includes a local wireless communication protocol and is configured to communicate with at least one mobile device using the local wireless communication protocol.

20. The residential security system of claim 18, wherein the door lock is directly connected to at least one of the central security system and a mobile credentialing server.
